(19) United States
(12) Patent Application Publication
(10) Pub. No.: US 2013/0047406 A1
(43) Pub. Date: Feb. 28, 2013

(54) DEVICE FOR SIMULTANEOUS ATTACHMENT AND FOLDING OF BRACKETS FOR ROOFING SHEET

(71) Applicant: Bjarne Svanberg, Sodertalje (SE)

(72) Inventor: Bjarne Svanberg, Sodertalje (SE)

(21) Appl. No.: 13/634,715

(22) PCT Filed: Mar. 17, 2011
(86) PCT No.: PCT/SE2011/050293

§ 371 Date: Sep. 26, 2012

(30) Foreign Application Priority Data
Mar. 19, 2010 (SE) 1050259-9

(51) Int. Cl. B23P 11/00

(52) U.S. Cl. 29/505; 29/283.5

(57) ABSTRACT

Device for simultaneous attachment and folding into a low flange of plate or sheet coverage of at least a part of an end portion of a connecting tongue of a bracket for roofing sheet to an underlay, said device comprises a hollow longitudinal housing (1), at a first end (2) of which is arranged a driving apparatus and at a second end (4) of which is arranged an elongated hollow means (5). A projecting end of the hollow means is provided with a folding device (10). When the folding device (10) is pressed against the underlay a first end (11a) of a folding arm (11) is given a radial motion, so that said first end (11a) of the folding arm (11) folds into the low flange at least a part of an end portion of the connecting tongue of the bracket mounted in the folding device while the bracket being attached to the underlay.

### FIELD OF THE INVENTION

The invention relates to a device for simultaneous attachment and folding into a low flange of at least a part of an end portion of a connecting tongue of brackets for roofing sheet to an underlay.

### BACKGROUND OF THE INVENTION

When covering a roof with plate or sheet coverage the plates/sheets are attached to an under-roofing, for example, by preferably brackets. These brackets are attached at regular distance along the low flange of the plates/sheets and are nailed or screwed to the under-roofing. The bracket is provided with a connecting tongue the end portion of which is folded into the low flange to thus secure respective plate/sheet to the under-roofing. Over this low flange with attached bracket is placed the high flange of next adjacent plate/sheet. Then the high and low flanges are folded together.

The folding in of the free end/end portion of the connecting tongue is difficult to make by hand, since large forces are needed, and is made by means of tools.

By the Swedish document SE 528 744 C2 it is known a bracket for roofing sheet having a connecting tongue whose free part is substantially U-shaped and whose one leg/end portion has a slit. This slit makes it possible to divide the end portion of the connecting tongue into two parts, thereby facilitating a manual folding of one of these two parts into the low flange. This can be done by little force and without tools. The other part is folded in connection with the folding together of the high and low flange.

A disadvantage of this method of attaching plate or sheet coverage for covering a roof by means of brackets is that the fastening will be divided in two operations, i.e. first the attachment of the bracket itself to the underlay/under-roofing and then folding in of at least one part of the end portion of the connecting tongue into the low flange, which increases the costs for roof covering.

### SUMMARY OF THE INVENTION

The object of the invention is to provide a device by means of which it is possible to simultaneously with the attachment, preferably by screwing or nailing, of the bracket to the under-roofing also folding at least a part of the end portion of the connecting tongue into the low flange.

This object is achieved by a device for simultaneous attachment and folding into a low flange of plate or sheet coverage of at least a part of an end portion of a connecting tongue of a bracket for roofing sheet to an underlay, characterized in that the device comprises a hollow longitudinal housing, at a first end of which is arranged a fixed or detachably mounted driving apparatus and at a second end of which is arranged an elongated hollow means, which is axially displaceable in the housing and which projects beyond the second end of the housing, the projecting end of the hollow means is provided with a folding device comprising a pivotably mounted folding arm, the folding of at least a part of the end portion of the connecting tongue is adapted to be achieved by an axial displacement between the housing and the folding device against each other, when the folding device is pressed against the underlay, a first end of the folding arm is given a radial motion by means of an actuation means arranged at the second end of the housing, so that said first end of the folding arm folds into the low flange at least a part of an end portion of the connecting tongue of the bracket mounted in the folding device while the bracket being attached to the underlay.

### BRIEF DESCRIPTION OF DRAWINGS

The inventions is described in detail below with reference to the accompanying drawings, on which

FIG. 1 is a side view of a device according to the invention by means of which it is possible to simultaneously with the attachment of a bracket for a roofing sheet also achieve folding in of at least a part of an end portion of the connecting tongue of a bracket into the low flange,

FIG. 2 is a further side view of the device in FIG. 1,

FIG. 3 is another side view of the device in FIG. 1, and

FIG. 4 is a view from below of the device in FIGS. 1-3.

### DESCRIPTION OF PREFERRED EMBODIMENTS

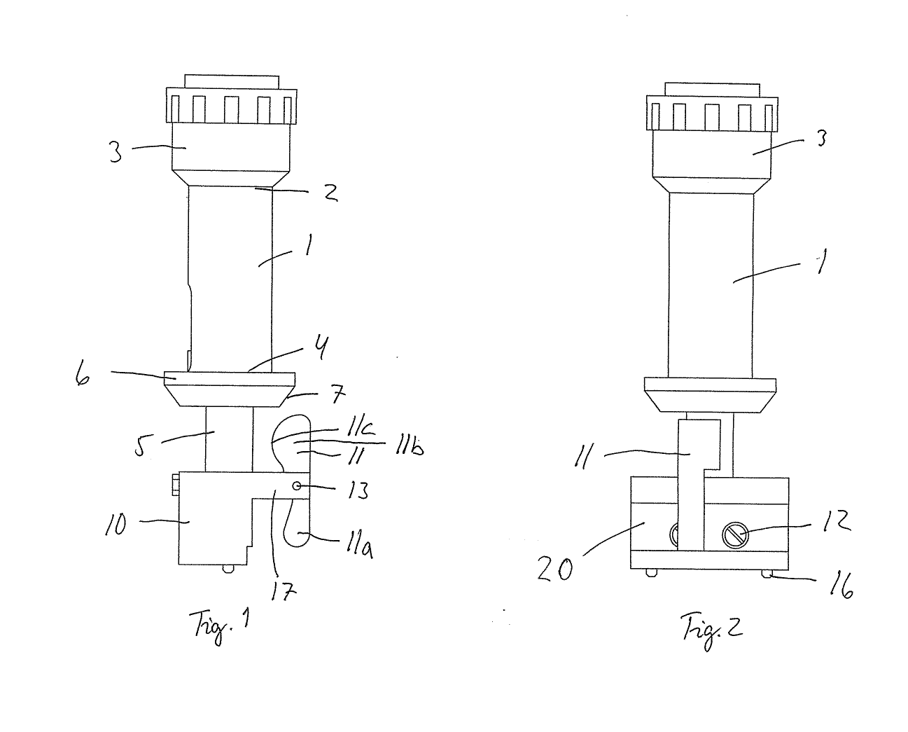

As shown in FIGS. 1-3 a device for simultaneously fastening and folding into a low flange of at least a part of an end portion of the connecting tongue of a bracket (not shown) at roofing sheet comprises a hollow elongated housing 1, a first end 2 of which, in a preferred embodiment, is provided with a socket 3 for detachable connection to a driving apparatus (not shown), preferably in a form of an electric screw driver or a nailer. It is obvious that, in another embodiment, the driving apparatus can be fixedly attached to the housing 1.

At a second end 4 of the housing an elongated hollow means 5 is arranged, which is axially displaceably arranged in the housing 1. The means 5 can be made in the form of a shaft 5, which projects outside the second end 4 of the housing. At the end of the hollow means projecting out of the housing is arranged a folding device 10, which includes a pivotable folding arm 11.

The bracket for roofing sheet, which preferably are used together with the device according to the invention, will not be described in more detail below, since it is described in the above-mentioned patent document.

In a preferred embodiment the driving apparatus is a driving apparatus provided with a rotatable driving shaft, which can be adapted to be connected to either a long bits (not shown) or an extension shaft (not shown), which extends through the housing 1, the hollow means 5 and into a through hole 15 in the folding device 10 (FIG. 4). In the case of the extension shaft it can either be provided with a suitable screwing means adapted for the screw which is pre-mounted in the bracket or a bits holder, in which a suitable bits for the pre-mounted screw is mounted. It should be noted that the holes in the hollow housing 1, the hollow means 5 and the folding device 10 are in line with each other.

When attaching the bracket to an underlay a folding in of at least a part of the end portion of the connecting tongue is carried out simultaneously. This is accomplished by an axial displacement between the housing 1 and the folding device 10 against each other, when the folding device is pressed against an underlay (not shown), such as an under-roofing, a first end 11a of the folding arm 11 is given a radial movement by means of an actuation means 6 arranged at the second end 4 of the housing, so that said first end folds in at least a part of the end portion of the connecting tongue of a bracket mounted in the folding device into the low flange.

In the case of the driving apparatus being a driving apparatus having a rotatable driving shaft the axial displacement between the housing and the folding device 10 will cause the screwing means/bits to engage the screw which is pre-mounted in the bracket, and as the screw is screwed into the underlay the actuation means 6 will progressively effect the folding arm for corresponding progressive folding of at least a part of the end portion of the connecting tongue into the low flange.

The bracket is adapted to be detachably attached to the folding device 10 by clamping the connecting tongue of the bracket between a surface 20 of the folding device 10 and a first end 11a of the folding arm, and/or the bracket is secured to the folding device using at least one magnet 12 (FIG. 2).

Moreover, as can be seen from FIG. 1, the folding device 10 is provided with an arm 17 projecting perpendicular to the axial direction of the hollow means 5 to form a substantially L-shaped body as seen in cross section. The folding arm 11 is pivotably mounted to the end of the arm 17 by a pin 13, about at its centre.

From FIGS. 1-3 it can be seen that the second end 4 of the housing 1 is provided with an actuation means 6 having a first surface 7, preferably an essentially conically shaped surface 7, directed towards the folding device 10. At an axial displacement between the housing 1 and the folding device 10 towards each other the conically shaped surface 7 is adapted to come into contact with a second end 11b of the folding arm 11 so as to achieve the radial movement of the first end 11a of the folding arm towards the folding device. The second end 11b of the folding arm 11 has a second surface 11c, and more particularly a rounded surface 11c as seen in the axial direction, said surface being adapted to cooperate with the conically shaped surface 7 of the actuation means 6, when the housing 1 is pressed against the folding device 10 so as to achieve a radial motion of the first end 11a of the folding arm 11 and thereby folding of at least a part of the end portion of the connecting tongue of the bracket into the low flange. The folding arm 11 is biased by means of a spring (not shown) towards its starting position, which is shown in FIG. 1, and the hollow means is biased towards its ejected position from the housing. The housing 1 and the hollow means 5 can thus perform a telescope motion relative to each other.

It is obvious for the man skilled in the art that the radial motion of the first end 11a of the folding arm 11 can be made by a different method than the one that has been specified above, such as that the above-mentioned interacting first surface 7 and second surface 11c are replaced by interacting toothed surfaces or a surface of the actuation means, for instance, which cooperates with a roller, a wheel or corresponding means of the folding arm. It is also possible to adapt instead the substantially conically shaped surface in the form of the second surface 11c instead of the first surface 7, or to arrange conically shaped surfaces at both the first and the second surfaces.

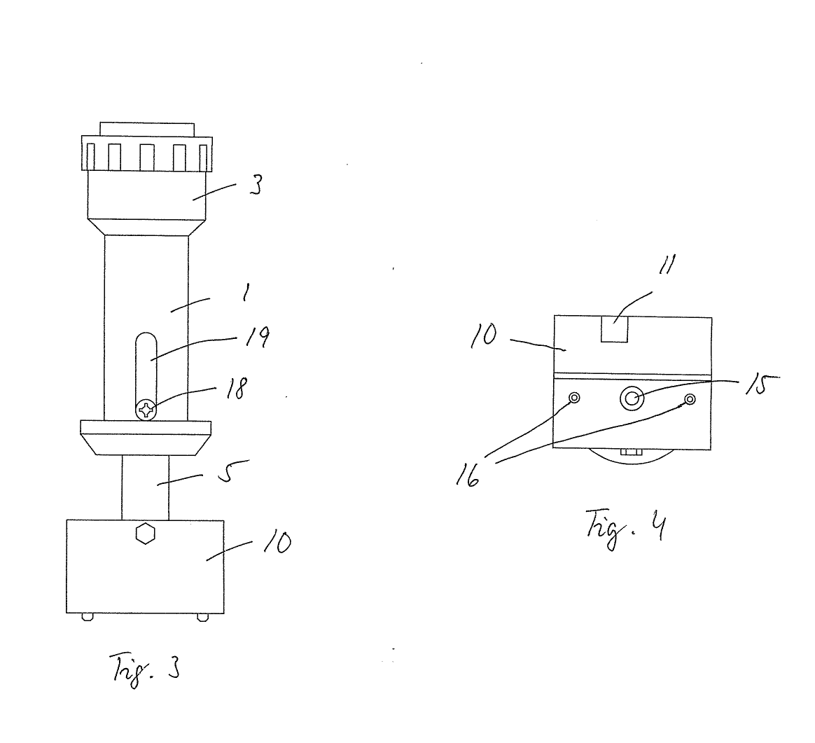

From FIG. 3 it can be seen that the axial displacement of the hollow means 5 in the housing 1 is limited by preferably a stop means 18, preferably a screw 18, which is adapted to run in a groove formed in the housing 1, between the axial end surfaces of the groove.

To prevent the bracket from turning when the bracket is attached to the underlay, the surface of the folding device 10 directed towards the underlay is provided with at least one, preferably two, guide pins 16 adapted to cooperate with corresponding guide holes in the bracket.

1-11. (canceled)

12. A device for simultaneous attachment of a bracket for roofing sheet to an underlay and folding into a low flange of plate or sheet coverage of at least a part of an end portion of a connecting tongue of said bracket, wherein
the device comprises a housing, at a first end of which is arranged a fixed or detachably mounted driving apparatus and at a second end of which is arranged a hollow means, which is axially displaceable relative to the housing and which projects beyond the second end of the housing, the projecting end of the hollow means being provided with a folding device comprising a pivotable folding arm having a first end, the device further comprising an actuation means arranged at the second end of the housing for giving, when the folding device is pressed against the housing thereby axially displacing the housing and the folding device against each other, a radial motion to said first end of said folding arm, so that said first end of the folding arm folds into the low flange said at least a part of an end portion of the connecting tongue of the bracket, mounted in the folding device, while the bracket is being attached to the underlay.

13. The device according to claim 12, wherein the actuation means is provided with a first surface directed towards the folding device, whereby, at axial displacement between the housing and the folding device against each other, the first surface is adapted to contact and to cooperate with a second surface of a second end of the folding arm so as to achieve the radial motion of the first end of the folding arm towards the bracket mounted in the folding device.

14. The device according to claim 13, wherein the first surface of the actuation means has a substantially conically shaped surface, and the second surface of the second end of the folding arm has a round surface as seen in the axial direction.

15. The device according to claim 12, wherein the folding device is provided with an arm which protrudes at right angle to the axial direction of the hollow means to form a substantially L-shaped body, as seen in cross section, and the folding arm is pivotably mounted at about its centre at the end of the arm.

16. The device according to claim 12, wherein the folding arm is biased towards its starting position, and the hollow means is biased towards its position protruding out of the housing.

17. The device according to claim 12, wherein the first end of the housing is provided with a socket for detachably mounting of the driving apparatus.

18. The device according to claim 12, wherein the driving apparatus is a driving apparatus provided with a rotatable drive shaft, at which drive shaft either a bits or an extension shaft having a bits socket, extending through the housing, the hollow means and into a through hole arranged in the folding device, is mounted for screwing in a screw pre-mounted in the bracket.

19. The device according to claim 12, wherein the driving apparatus is a nailer.

20. The device according to claim 12, wherein the surface of the folding device directed towards the underlay is provided with at least one, preferably two, guide pins for cooperation with corresponding guide holes in the bracket.

21. The device according to claim 12, wherein the bracket is adapted to be detachably fixed to the folding device by clamping the connecting tongue of the bracket between a surface of the folding device and the first end of the folding arm.

22. The device according to claim 12, wherein the folding device is provided with magnets for detachable attachment of the bracket to the folding device.

23. A method of attaching a bracket for roofing sheet, the method comprising attaching said bracket to an underlay using a driving apparatus, and wherein simultaneously with attaching said bracket to the underlay, folding at least a part of an end portion of a connecting tongue of said bracket into a low flange of plate or sheet coverage by
axially displacing a housing, which is arranged at the driving apparatus, towards a folding device,
the housing thereby actuating upon a folding arm such that a first end of said folding arm folds said at least a part of an end portion of a connecting tongue of said bracket into a low flange of plate or sheet coverage.
